(19) United States
(12) Patent Application Publication
(10) Pub. No.: US 2024/0123980 A1
(43) Pub. Date: Apr. 18, 2024

(54) METHOD AND A SYSTEM FOR PREDICTING AN ACCIDENT OF A VEHICLE

(71) Applicant: HERE Global B.V., Eindhoven (NL)

(72) Inventors: Leon STENNETH, Chicago, IL (US); Bruce BERNHARDT, Wauconda, IL (US); Advait Mohan RAUT, Virar West, MH (IN)

(21) Appl. No.: 17/968,590

(22) Filed: Oct. 18, 2022

(51) Int. Cl. B60W 30/095; B60W 40/08

(52) U.S. Cl. CPC B60W 30/095; B60W 40/08; B60W 2040/089; B60W 2420/54; B60W 2510/18

(57) ABSTRACT

The disclosure provides a method, a system, and a computer program product for predicting an accident. The method comprises capturing one or more audio signals based on one or more sensors onboard a vehicle. The method may include extracting one or more features associated with each of the one or more audio signals. The method further includes, generating an output for predicting the accident, based on the extracted one or more features associated with each of the one or more audio signals. Further, the output comprises a predicted accident state and an associated confidence value. Also, the predicted accident state comprising at least one of: a no accident state, a pre-accident state, a light accident state, and an intense accident state.

### TECHNOLOGICAL FIELD

The present disclosure generally relates to a vehicle accident detection and prevention system, and more particularly relates to a system and a method for predicting an accident of a vehicle.

### BACKGROUND

At present, various sensors are used for determining an accident of a vehicle. Such sensors are either installed in the vehicle or installed on a road where the vehicle is moving. These sensors can be speed sensors, seat belt sensors, light sensors, airbag sensors, or a camera installed on the road where the vehicle is moving etc. Using inputs from these sensors, an accident can be determined but after the vehicle has met the accident. For example, information of an air bag (in an already deployed state) of the vehicle and hazard lights are used to detect and report an accident from the vehicle to a backend service to provide warning polygons/regions for other upcoming vehicles.

However, there is a need for an improved system and a method for predicting an accident of a vehicle in a timely manner using input/s from other sensors available in the vehicle.

### BRIEF SUMMARY

Accordingly, there is a need of a solution currently that can predict an accident of a vehicle in advance not only using input/s from above-mentioned sensors but also from other sensors available in the vehicle.

Accordingly, there is a need for predicting an accident of a vehicle in advance using input/s from other sensors available in the vehicle. In order to predict the accident of the vehicle in advance, it is important to use other sources or inputs from other sensors already available in the vehicle. Such other sensors already available in the vehicle are audio-related inputs or sensors in the vehicle which are provided as an input. Using the audio-related inputs of the vehicle, an output is generated along with a confidence score for predicting the accident of the vehicle. The output generated is one of following: a no accident state, a pre-accident sate, a light accident sate, and an intense accident state. Example embodiments of the present disclosure provide a system, a method, and a computer program product for predicting the accident of the vehicle.

Some example embodiments disclosed herein provide a method for predicting an accident of a vehicle. The method comprises capturing one or more audio signals based on one or more sensors onboard a vehicle. The method may include extracting one or more features associated with each of the one or more audio signals. The method may further include generating an output for predicting the accident, based on the extracted one or more features associated with each of the one or more audio signals. Further, the output comprises a predicted accident state and an associated confidence value, wherein the predicted accident state comprising at least one of: a no accident state, a pre-accident state, a light accident state, and an intense accident state.

According to some example embodiments, the captured one or more audio signals comprise audio associated with at least one of: braking events, accident collision impact, a horn, or a passenger sound, like a scream or a conversation.

According to some example embodiments, the pre-accident state comprises detection of the audio of the braking events, audio of the horn and audio from the passengers.

According to some example embodiments, the pre-accident state further comprising triggering a vehicle's air bag.

According to some example embodiments, the method further comprises the step of sending an alert based on the pre-accident state detection.

According to some example embodiments, the light accident state comprises detection of the audio of the braking events, audio of the horn, audio from the passengers and accident collision impact wherein the collision impact is less than a first threshold.

According to some example embodiments, the intense accident state comprises detection of the audio of the braking events, audio of the horn, audio from the passengers and accident collision impact wherein the collision impact is greater than a second threshold.

According to some example embodiments, the no accident state comprises absence of the captured audio signals.

According to some example embodiments, the output is further validated using non-audio data if the confidence value is below a third threshold.

According to some example embodiments, the non-audio data comprising at least one of: an imagery of an environment of the vehicle, a probe data from other vehicles.

According to some example embodiments, the output is generated using machine learning algorithm.

Some example embodiments disclosed herein provide a system for predicting an accident of a vehicle, the system comprising a memory configured to store computer-executable instructions and one or more processors configured to execute the instructions to capture one or more audio signals based on one or more sensors onboard a vehicle. The one or more processors are further configured to extract one or more features associated with each of the one or more audio signals. The one or more processors are further configured to generate an output for predicting the accident, based on the extracted one or more features associated with each of the one or more audio signals, wherein the output comprises a predicted accident state and an associated confidence value, wherein the predicted accident state comprising at least one of: a no accident state, a pre-accident state, a light accident state, and an intense accident state.

Some example embodiments disclosed herein provide a computer programmable product comprising a non-transitory computer readable medium having stored thereon computer executable instruction which when executed by one or more processors, cause the one or more processors to carry out operations for predicting an accident of a vehicle, the operations comprising capturing one or more audio signals based on one or more sensors onboard a vehicle. The operations further comprise extracting one or more features associated with each of the one or more audio signals. The operations further comprise generating an output for predicting the accident, based on the extracted one or more features associated with each of the one or more audio signals, wherein the output comprises a predicted accident state and an associated confidence value, wherein the predicted accident state comprising at least one of: a no accident state, a pre-accident state, a light accident state, and an intense accident state.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram of a network environment of a system for predicting an accident, in accordance with an example embodiment;

FIG. 2A illustrates a block diagram of a system for predicting an accident, in accordance with an example embodiment;

FIG. 2B illustrates an exemplary map database record storing data, in accordance with one or more example embodiments;

FIG. 2C illustrates another exemplary map database record storing data, in accordance with one or more example embodiments;

FIG. 2D illustrates another exemplary map database storing data, in accordance with one or more example embodiments;

FIG. 3 illustrates various audio inputs and outputs of the system for predicting an accident, in accordance with an example embodiment;

FIG. 4 illustrates an exemplary scenario of triggering an airbag of a vehicle in a pre-accident state, in accordance with an example embodiment;

FIG. 5 illustrates an exemplary scenario of sending an alert based on a pre-accident state, in accordance with an example embodiment; and

FIG. 6 illustrates a flow diagram of a method for predicting an accident, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “route” may be used to refer to a path from a source location to a destination location on any link.

The term “autonomous vehicle” may refer to any vehicle having autonomous driving capabilities at least in some conditions. An autonomous vehicle, as used throughout this disclosure, may refer to a vehicle having autonomous driving capabilities at least in some conditions. The autonomous vehicle may also be known as a driverless car, robot car, self-driving car, or autonomous car. For example, the vehicle may have zero passengers or passengers that do not manually drive the vehicle, but the vehicle drives and maneuvers automatically. There can also be semi-autonomous vehicles or a manually driven vehicle.

The term “machine learning model” may be used to refer to a computational or statistical or mathematical model that is based in part or on the whole on artificial intelligence and deep learning techniques. The “machine learning model” is trained over a set of data and using an algorithm that it may use to learn from the dataset.

### End of Definitions

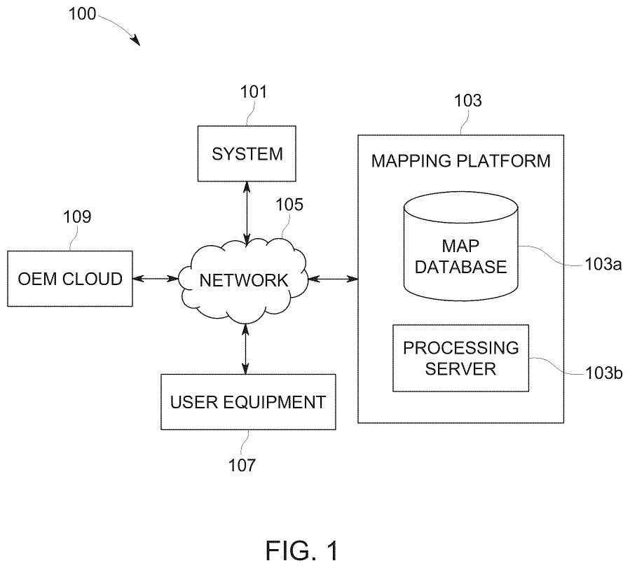

Embodiments of the present disclosure may provide a system, a method, and a computer program product for predicting an accident of a vehicle. The system, the method, and the computer program product predicting an accident of a vehicle in such an improved manner are described with reference to FIG. 1 to FIG. 6 as detailed below.

FIG. 1 illustrates a block diagram of a network environment 100 of a system 101 predicting an accident of a vehicle, in accordance with an example embodiment. The system 101 may be communicatively coupled to a mapping platform 103, a user equipment 107 and an OEM (Original Equipment Manufacturer) cloud 109 via a network 105. The components described in the network environment 100 may be further broken down into more than one component such as one or more sensors or application in the system 101 and/or combined together in any suitable arrangement. Further, it is possible that one or more components may be rearranged, changed, added, and/or removed.

In an example embodiment, the system 101 may be embodied in one or more of several ways as per the required implementation. For example, the system 101 may be embodied as a cloud-based service or a cloud-based platform. In each of such embodiments, the system 101 may be communicatively coupled to the components shown in FIG. 1 to carry out the desired operations and wherever required modifications may be possible within the scope of the present disclosure. The system 101 may be implemented in a vehicle, where the vehicle may be an autonomous vehicle, a semi-autonomous vehicle, or a manually driven vehicle. Further, in one embodiment, the system 101 may be a standalone unit configured to predicting an accident of a vehicle. Alternatively, the system 101 may be coupled with an external device such as the autonomous vehicle. In an embodiment, the system 101 may also be referred to as the UE 107. In some example embodiments, the system 101 may be any user accessible device such as a mobile phone, a smartphone, a portable computer, and the like that are portable in themselves or as a part of another portable/mobile object such as a vehicle. The system 101 may comprise a processor, a memory, and a communication interface. The processor, the memory and the communication interface may be communicatively coupled to each other. In some example embodiments, the system 101 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to a user based on a prediction of a vehicle's accident. In such example embodiments, the system 101 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of system 101. Additional, different, or fewer components may be provided. For example, the system 101 may be configured to execute and run mobile applications such as a messaging application, a browser application, a navigation application, and the like. For example, system 101 may be a dedicated vehicle (or a part thereof) for gathering data related to accident of other vehicles in a database map 103a. For example, the system 101 may be a consumer vehicle (or a part thereof). In some example embodiments, the system 101 may serve the dual purpose of a data gatherer and a beneficiary device. The system 101 may be configured to capture sensor data associated with the vehicle or a road which the system 101 may be traversing. The sensor data may for example be audio signals in and outside the vehicle, image data of road objects, road signs, or the surroundings (for example buildings). The sensor data may refer to sensor data collected from a sensor unit in the system 101. In accordance with an embodiment, the sensor data may refer to the data captured by the vehicle using sensors.

In some other embodiments, the system 101 may be an OEM (Original Equipment Manufacturer) cloud, such as the OEM cloud 109. The OEM cloud 109 may be configured to anonymize any data received from the system 101, such as the vehicle, before using the data for further processing, such as before sending the data to the mapping platform 103. In some embodiments, anonymization of data may be done by the mapping platform 103.

The mapping platform 103 may comprise a map database 103a for storing map data and a processing server 103b. The map database 103a may include data associated with vehicle's accidents on road/s, one or more of a road sign, or speed signs, or road objects on the link or path. Further, the map database 103a may store accident data, node data, road segment data, link data, point of interest (POI) data, link identification information, heading value records, or the like. Also, the map database 103a further includes speed limit data of each lane, cartographic data, routing data, and/or maneuvering data. Additionally, the map database 103a may be updated dynamically to cumulate real time traffic conditions based on prediction of vehicle's accident. The real time traffic conditions may be collected by analyzing the location transmitted to the mapping platform 103 by a large number of road users travelling by vehicles through the respective user devices of the road users. In one example, by calculating the speed of the road users along a length of road, the mapping platform 103 may generate a live traffic map, which is stored in the map database 103a in the form of real time traffic conditions based on prediction of vehicle's accident. In one embodiment, the map database 103a may further store historical traffic data that includes travel times, accident prone areas, areas with least and maximum accidents, average speeds and probe counts on each road or area at any given time of the day and any day of the year. According to some example embodiments, the road segment data records may be links or segments representing roads, streets, or paths, as may be used in calculating a route or recorded route information for determination of one or more personalized routes to avoid a zone/route with the predicted accident. The node data may be end points corresponding to the respective links or segments of road segment data. The road link data and the node data may represent a road network used by vehicles such as cars, trucks, buses, motorcycles, and/or other entities. Optionally, the map database 103a may contain path segment and node data records, such as shape points or other data that may represent pedestrian paths, links, or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, vehicle accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services in an event of a predicted vehicle's accident, such as route calculation, route guidance, map display, speed calculation, distance and travel time functions, and other functions, by a navigation device, such as by the system 101 or by the user equipment 107. The navigation-related functions may correspond to vehicle navigation, pedestrian navigation, or other types of navigation to avoid a zone where the vehicle accident has been predicted by the system 101. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in the system 101 to provide navigation and/or map-related functions in an event of a predicted vehicle's accident. For example, the map database 103a may be used with the system 101 to provide an end user with navigation features. In such a case, the map database 103a may be downloaded or stored locally (cached) on the system 101.

The processing server 103b may comprise processing means, and communication means. For example, the processing means may comprise one or more processors configured to process requests received from the system 101. The processing means may fetch map data from the map database 103a and transmit the same to the system 101 via the OEM cloud 109 in a format suitable for use by the system 101. In one or more example embodiments, the mapping platform 103 may periodically communicate with the system 101 via the processing server 103b to update a local cache of the map data stored on the system 101. Accordingly, in some example embodiments, the map data may also be stored on the system 101 and may be updated based on periodic communication with the mapping platform 103. In some embodiments, the map data may also be stored on the user equipment 107 and may be updated based on periodic communication with the mapping platform 103.

In some example embodiments, the user equipment 107 may be any user accessible device such as a mobile phone, a smartphone, a portable computer, and the like, as a part of another portable/mobile object such as a vehicle. The user equipment 107 may comprise a processor, a memory, and a communication interface. The processor, the memory and the communication interface may be communicatively coupled to each other. In some example embodiments, the user equipment 107 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user equipment 105 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 107. Additional, different, or fewer components may be provided. In one embodiment, the user equipment 107 may be directly coupled to the system 101 via the network 105. For example, the user equipment 107 may be a dedicated vehicle (or a part thereof) for gathering data for development of the map data in the database 103a. In some example embodiments, at least one user equipment such as the user equipment 107 may be coupled to the system 101 via the OEM cloud 109 and the network 105. For example, the user equipment 107 may be a consumer vehicle (or a part thereof) and may be a beneficiary of the services provided by the system 101. In some example embodiments, the user equipment 107 may serve the dual purpose of a data gatherer and a beneficiary device. The user equipment 107 may be configured to capture sensor data associated with a road which the user equipment 107 may be traversing. The sensor data may for example be image data of road objects, road signs, or the surroundings. The sensor data may refer to sensor data collected from a sensor unit in the user equipment 107. In accordance with an embodiment, the sensor data may refer to the data captured by the vehicle using sensors. The user equipment 107, may be communicatively coupled to the system 101, the mapping platform 103 and the OEM cloud 109 over the network 105.

The network 105 may be wired, wireless, or any combination of wired and wireless communication networks, such as cellular, Wi-Fi, internet, local area networks, or the like. In one embodiment, the network 105 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an example, the mapping platform 103 may be integrated into a single platform to provide a suite of mapping and navigation related applications for OEM devices, such as the user devices and the system 101. The system 101 may be configured to communicate with the mapping platform 103 over the network 105. Thus, the mapping platform 103 may enable provision of cloud-based services for the system 101, such as, storing the lane marking observations in an OEM cloud in batches or in real-time.

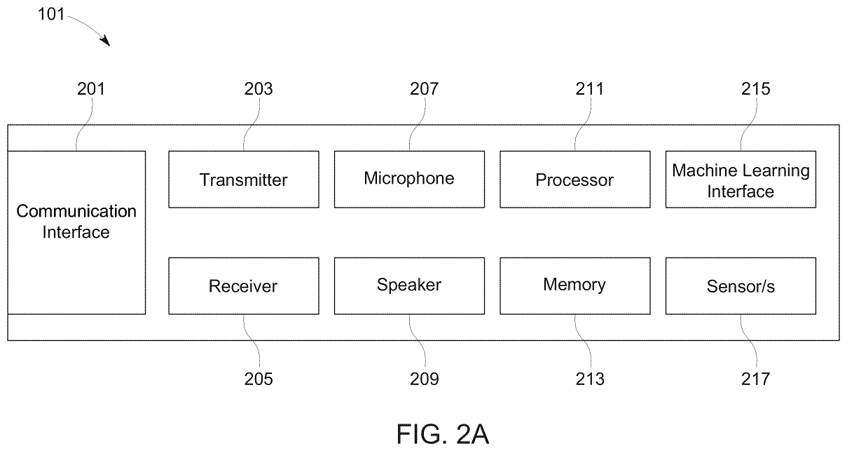

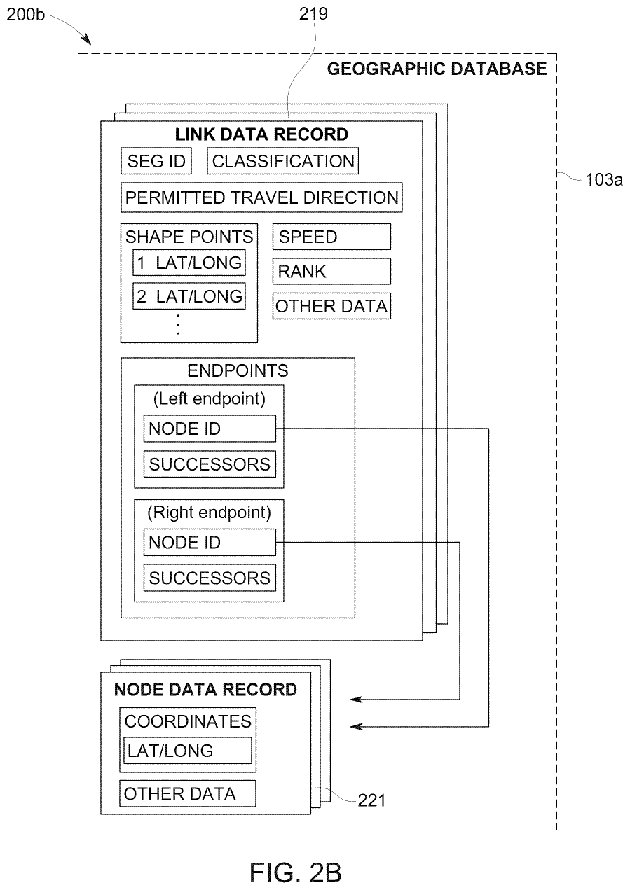

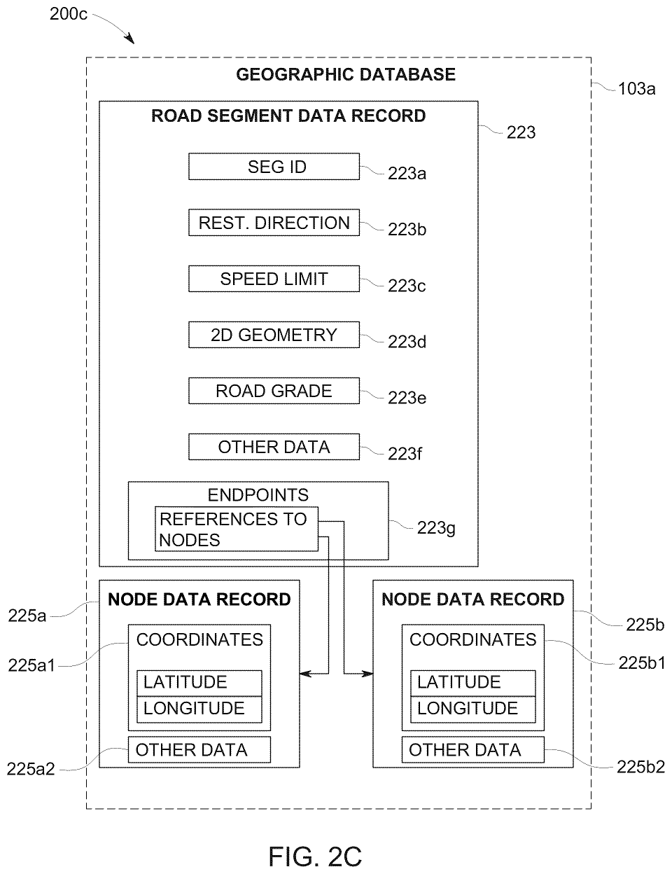

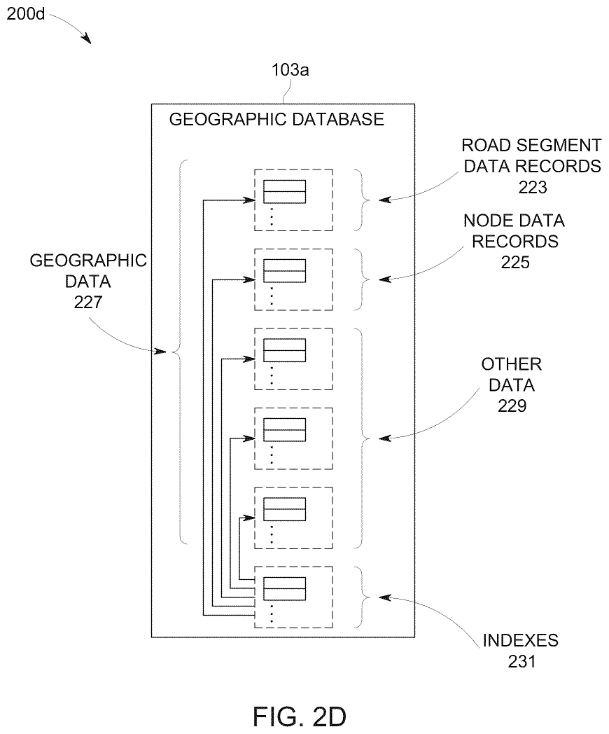

FIG. 2A illustrates a block diagram of a system 101 for predicting an accident of a vehicle, in accordance with an example embodiment. The system 101 may include, but is not limited to, a communication means such as at least one communication interface 201 (hereinafter, also referred to as “communication interface 201”), a transmitter 203, a receiver, 205, a microphone 207, a speaker 209, a processing means such as at least one processor 211 (hereinafter, also referred to as “processor 211”), storage means such as at least one memory 213 (hereinafter, also referred to as “memory 213”), and a machine learning model 215 and one or more sensors 217.

The system 101 may be accessed using the communication interface 201. The communication interface 201 may provide an interface for accessing various features and data stored in the system 101. The communication interface 201 may comprise input interface and output interface for supporting communications to and from the system 101 or any other component with which the system 101 may communicate. The communication interface 201 may be any means such as a device or circuitry embodied in either hardware or a combination of hardware and software that is configured to receive and/or transmit data to/from a communications device in communication with the system 101. In this regard, the communication interface 201 may include, for example, an antenna (or multiple antennae) and supporting hardware and/or software for enabling communications with a wireless communication network. Additionally, or alternatively, the communication interface 201 may include the circuitry for interacting with the antenna(s) to cause transmission of signals via the antenna(s) or to handle receipt of signals received via the antenna(s). In some environments, the communication interface 201 may alternatively or additionally support wired communication. As such, for example, the communication interface 201 may include a communication modem and/or other hardware and/or software for supporting communication via cable, digital subscriber line (DSL), universal serial bus (USB) or other mechanisms. In some embodiments, the communication interface 201 may enable communication with a cloud-based network to enable federated learning, such as using the machine learning model 215.

The transmitter 203 of the system 101 may transmit an update regarding a predicted accident to the mapping platform 103 so as to enable the mapping platform 103 to update the map database 103a. The transmitter 203 of the system 101 may also transmit an alert to nearby vehicles about the predicted accident of the vehicle to avoid an accident zone. The transmitter 203 of the system 101 may also transmit an alert to nearby hospitals to send an ambulance to the accident zone.

The receiver 205 of the system 101 may receive updates or information from the mapping platform 103, the nearby vehicles or from the nearby hospitals or police station for providing emergency assistance to the passenger of the accident vehicle, in case of an accident.

The microphone 207 of the system 101 may be communicably coupled with the one or more sensors 217 to capture audio signals associated with a vehicle. These audio signals are explained below in greater details.

The speaker 209 of the system 101 may output an audio message to provide navigation guidance to a passenger of the vehicle having or associated with the system 101. In some embodiments, the audio message is received from the mapping platform 103, the nearby vehicles or from the nearby hospitals or police station for providing emergency assistance to the passenger of the accident vehicle.

The processor 211 may retrieve computer program code instructions that may be stored in the memory 213 for execution of the computer program code instructions.

The processor 211 may be embodied in a number of different ways. For example, the processor 211 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 211 may include one or more processing cores configured to perform independently. A multi-core processor may enable multiprocessing within a single physical package. Additionally, or alternatively, the processor 211 may include one or more processors configured in tandem via the bus to enable independent execution of instructions, pipelining and/or multithreading.

In some embodiments, the processor 211 may be configured to provide Internet-of-Things (IoT) related capabilities to users of the system 101, where the users may be a traveler, a rider, a pedestrian, and the like. In some embodiments, the users may be or correspond to manually driven vehicle, an autonomous or a semi-autonomous vehicle. The IoT related capabilities may in turn be used to provide smart navigation solutions by providing real time updates to the users to take pro-active decision on predicted accident of the vehicle, turn-maneuvers, lane changes, overtaking, merging and the like, big data analysis, and sensor-based data collection by using the cloud-based mapping system for providing navigation recommendation services to the users based on prediction of the accident of the vehicle.

Additionally, or alternatively, the processor 211 may include one or more processors capable of processing large volumes of workloads and operations to provide support for big data analysis. In an example embodiment, the processor 211 may be in communication with the memory 213 via a bus for passing information among components coupled to the system 101.

The memory 213 may be non-transitory and may include, for example, one or more volatile and/or non-volatile memories. In other words, for example, the memory 213 may be an electronic storage device (for example, a computer readable storage medium) comprising gates configured to store data (for example, bits) that may be retrievable by a machine (for example, a computing device like the processor 211). The memory 213 may be configured to store information, data, content, applications, instructions, or the like, for enabling the apparatus to carry out various functions in accordance with an example embodiment of the present invention. For example, the memory 213 may be configured to buffer input data for processing by the processor 211. As exemplarily illustrated in FIG. 2A, the memory 213 may be configured to store instructions for execution by the processor 211. As such, whether configured by hardware or software methods, or by a combination thereof, the processor 211 may represent an entity (for example, physically embodied in circuitry) capable of performing operations according to an embodiment of the present invention while configured accordingly. Thus, for example, when the processor 211 is embodied as an ASIC, FPGA or the like, the processor 211 may be specifically configured hardware for conducting the operations described herein. Alternatively, as another example, when the processor 211 is embodied as an executor of software instructions, the instructions may specifically configure the processor 211 to perform the algorithms and/or operations described herein when the instructions are executed. However, in some cases, the processor 211 may be a processor specific device (for example, a mobile terminal or a fixed computing device) configured to employ an embodiment of the present invention by further configuration of the processor 211 by instructions for performing the algorithms and/or operations described herein. The processor 211 may include, among other things, a clock, an arithmetic logic unit (ALU) and logic gates configured to support operation of the processor 211.

The machine learning model 215 may refer to learning of the data to determine certain type of pattern based on some particular instructions or machine learning algorithm. The machine learning model 215 may include Deep Neural Network (DNN) that includes deep learning of the data using a machine learning algorithm. The purpose of DNN is to predict the result which otherwise are given by human brain. For this purpose, the DNN is trained on large sets of data. In an example embodiment, the system 101 may also use a federated learning model for training the dataset for the DNN. For example, the machine learning model 215 may a federated learning model. In an embodiment, federated learning basically allows training deep neural networks on a user's private data without exposing it to the rest of the world. Additionally, federated learning may allow for deep neural networks to be deployed on a user system, such as the system 101, and to learn using their data locally.

The machine learning model 215 is provided with pre-recorded or historical audio data on accident, light accident, and intense accident to train the model to predict an output correctly.

In some embodiments, the machine learning model 215 is embodied within the processor 211, and the representation shown in FIG. 2A is for exemplary purpose only. The machine learning model 215 may provide the necessary intelligence needed by the system 101.

FIG. 2B shows format of the map data 200b stored in the map database 103a according to one or more example embodiments. FIG. 2B shows a link data record 219 that may be used to store data about one or more of the feature lines. This link data record 219 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 219 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 103 and its associated map database developer selects one or more shape points along the other-than-straight road portion. Shape point data included in the link data record 219 indicate the position, (e.g., latitude, longitude, and optionally, altitude or elevation) of the selected shape points along the represented link.

Additionally, in the compiled geographic database, such as a copy of the map database 103a, there may also be a node data record 221 for each node. The node data record 221 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 2C shows another format of the map data 200c stored in the map database 103a according to one or more example embodiments. In the FIG. 2C, the map data 200c is stored by specifying a road segment data record 223. The road segment data record 223 is configured to represent data that represents a road network. In FIG. 2C, the map database 103a contains at least one road segment data record 223 (also referred to as “entity” or “entry”) for each road segment in a geographic region.

The map database 103a that represents the geographic region of FIG. 2A also includes a database record 225 (a node data record 225a and a node data record 225b) (or “entity” or “entry”) for each node associated with the at least one road segment shown by the road segment data record 223. (The terms “nodes” and “segments” represent only one terminology for describing these physical geographic features and other terminology for describing these features is intended to be encompassed within the scope of these concepts). Each of the node data records 225a and 225b may have associated information (such as “attributes”, “fields”, etc.) that allows identification of the road segment(s) that connect to it and/or its geographic position (e.g., its latitude and longitude coordinates).

FIG. 2C shows some of the components of the road segment data record 223 contained in the map database 103a. The road segment data record 223 includes a segment ID 223a by which the data record can be identified in the map database 103a. Each road segment data record 223 has associated with it information (such as “attributes”, “fields”, etc.) that describes features of the represented road segment. The road segment data record 223 may include data 223b that indicate the restrictions, if any, on the direction of vehicular travel permitted on the represented road segment. The road segment data record 223 includes data 223c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 223 may also include data 223d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 223 also includes road grade data 223e that indicate the grade or slope of the road segment. In one embodiment, the road grade data 223e include road grade change points and a corresponding percentage of grade change. Additionally, the road grade data 223e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 223e includes the road grade change points and an actual road grade value for the portion of the road segment after the road grade change point until the next road grade change point or end node. In a further embodiment, the road grade data 223e includes elevation data at the road grade change points and nodes. In an alternative embodiment, the road grade data 223e is an elevation model which may be used to determine the slope of the road segment.

The road segment data record 223 also includes data 223g providing the geographic coordinates (e.g., the latitude and longitude) of the end points of the represented road segment. In one embodiment, the data 223g are references to the node data records 223 that represent the nodes corresponding to the end points of the represented road segment.

The road segment data record 223 may also include or be associated with other data 223f that refer to various other attributes of the represented road segment. The various attributes associated with a road segment may be included in a single road segment record or may be included in more than one type of record which cross-reference each other. For example, the road segment data record 223 may include data identifying the name or names by which the represented road segment is known, the street address ranges along the represented road segment, and so on.

FIG. 2C also shows some of the components of the node data record 225 contained in the map database 103a. Each of the node data records 225 may have associated information (such as “attributes”, “fields”, etc.) that allows identification of the road segment(s) that connect to it and/or it's geographic position (e.g., its latitude and longitude coordinates). For the embodiment shown in FIG. 2C, the node data records 225a and 225b include the latitude and longitude coordinates 225a1 and 225b1 for their nodes. The node data records 225a and 225b may also include other data 225a2 and 225b2 that refer to various other attributes of the nodes.

Thus, the overall data stored in the map database 103a may be organized in the form of different layers for greater detail, clarity, and precision. Specifically, in the case of high-definition maps, the map data may be organized, stored, sorted, and accessed in the form of three or more layers. These layers may include road level layer, lane level layer and localization layer. The data stored in the map database 103a in the formats shown in FIGS. 2B and 2C may be combined in a suitable manner to provide these three or more layers of information. In some embodiments, there may be lesser or fewer number of layers of data also possible, without deviating from the scope of the present disclosure.

FIG. 2D illustrates a block diagram 200d of the map database 103a storing map data or geographic data 227 in the form of road segments/links, nodes, and one or more associated attributes as discussed above. Furthermore, attributes may refer to features or data layers associated with the link-node database, such as an HD lane data layer.

In addition, the map data 227 may also include other kinds of data 229. The other kinds of data 229 may represent other kinds of geographic features or anything else. The other kinds of data may include point of interest data. For example, the point of interest data may include point of interest records comprising a type (e.g., the type of point of interest, such as restaurant, ATM, etc.), location of the point of interest, a phone number, hours of operation, etc. The map database 103a also includes indexes 231. The indexes 231 may include various types of indexes that relate the different types of data to each other or that relate to other aspects of the data contained in the geographic database 103a.

The data stored in the map database 103a in the various formats discussed above may help in provide precise data for high-definition mapping applications, autonomous vehicle navigation and guidance, cruise control using ADAS, direction control using accurate vehicle maneuvering and other such services. In some embodiments, the system 101 accesses the map database 103a storing data in the form of various layers and formats depicted in FIGS. 2B-2D.

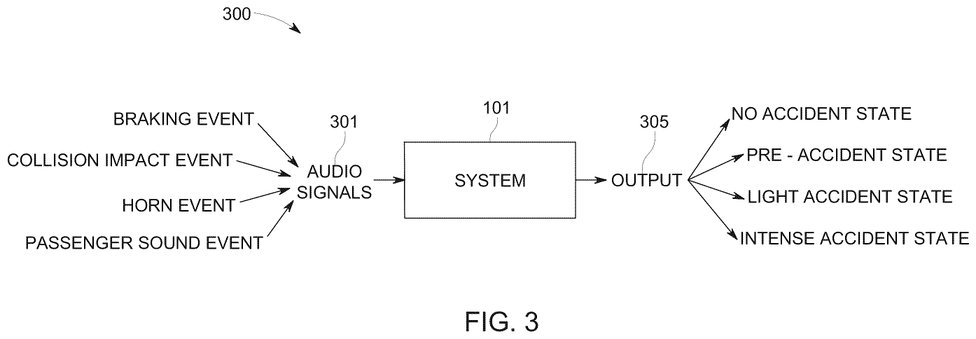

FIG. 3 illustrates various audio inputs and outputs of the system 101 for predicting an accident, in accordance with an example embodiment. The microphone 207 of the system 101 (shown in FIG. 2A) may be communicably coupled with the one or more sensors 217 of the system 101 to capture audio signals 301 associated with a vehicle. As shown in FIG. 3, four types of different audio signals 301 can be captured based on the one or more sensors 217 onboarded in the vehicle. In an exemplary embodiment, the one or more sensors 217 corresponds to an audio or a sound sensor embedded or integrated in an interior of the vehicle. In another exemplary embodiment, the one or more sensors 217 corresponds to an audio or a sound sensor embedded or integrated in an exterior of the vehicle. These audio signals 301 are captured while the vehicle is moving or on the way.

The audio signals 301 comprise at least one of: a braking event, a collision impact event, a horn event, or a passenger sound event. Herein, the audio signals 301 related to the braking events are generated and can be captured by the microphone 207 and/or the one or more sensors 217 when a vehicle brakes heavily when the vehicle is about to crash. When the vehicle's brakes are activated, the tire skids on the road pavement generating a very unique audio signal. Similarly, audio signals 301 related to the collision impact event are generated and can be captured by the microphone 207 and/or the one or more sensors 217 when the vehicle collides with other vehicle or with some objects (such a divider, tress, people etc.) on a road. Likewise, audio signals 301 related to the horn event are generated and can be captured by the microphone 207 and/or the one or more sensors 217 when the vehicle is about to crash, and driver of such vehicle tends to blow the horn. Lastly, audio signals 301 related to the passenger sound event are generated and can be captured by the microphone 207 and/or the one or more sensors 217 when passengers on board the vehicle realize that an accident is about to happen and becomes terrified. Such noise from the vehicle's passengers include screams.

Further, the audio or a sound sensor/s of the vehicle, continuously or over a period of time, senses the audio inside the vehicle as well as outside the vehicle by the microphone 207 along with the one or more sensors 217. For an instance, the audio signals 301 such as the braking event and the collision impact event can be captured from outside the vehicle. This is due to the reason that tire skidding audio because of the braking event and the collision impact audio can better be heard and sensed from outside the vehicle and not from inside the vehicle. Further, the audio signals 301 like the horn event or the passenger sound event can be captured well from inside the vehicle. This is due to the reason that if audio signals like the horn event or the passenger sound event are captured from outside the vehicle, these audio signals from one vehicle may get combined or mixed with horn audio or the passenger audio signals coming from other nearby vehicle. Thus, some audio signals like the horn event or the passenger sound event are better to be captured from inside the vehicle.

The processor 211 of the system 101 may communicate with the microphone 207 along with the one or more sensors 217 to retrieve the audio signals 301. The processor 211 of the system 101 may then extract one or more features associated with each of the audio signals 301. In an exemplary embodiment, the one or more features corresponds to an amplitude and/or a frequency of the audio signals 301. For each of the captured audio signals, an amplitude and/or a frequency of the captured audio signal is extracted by the processor 211.

The one or more extracted features associated with each of the audio signals 301 may be fed to the machine learning model 215 for training purpose as well as for determining an output 305. The machine learning model 215 may be communicably coupled with the processor 211 of the system 101 to determine the output 305 and predict the accident.

The processor 211 of the system 101 may generate the output 305 for predicting the accident, based on the extracted one or more features associated with each of the one or more audio signals 301. The output 305 may further comprise a predicted accident state and an associated confidence value for the output 305. The predicted accident state may be comprising at least one of: a no accident state, a pre-accident state, a light accident state, and an intense accident state. The output 305 is generated using machine learning algorithm as implemented by the machine learning interface 215 and the processor 211 of the system 101 explained above in FIG. 2A.

In order to generate the output 305 and the associated confidence value for the output 305, a rule-based algorithm may be implemented by the processor 211 of the system 101. In the rule-based algorithm for outputting the light accident state, the processor 211 detects all four types of audios i.e. the braking audio, the collision impact audio, the horn audio and/or the passenger audio. Further, the processor 211 determines that the collision impact (i.e. amplitude and/or the frequency of the collision impact audio) is less than a first threshold, then an output with the light accident state is generated by the processor 211 of the system 101. Such first threshold may be set automatically by the system 101 or may also be manually configured by a user of the system 101. In other words, the passengers are screaming, the vehicle's horn is also buzzing, and vehicle's brakes are applied in a hard manner, but two vehicles have just touched each other without colliding hardly and without any loud impact. This leads to an output generation of the light-accident state implying a light accident has happened.

In the rule-based algorithm for outputting the intense accident state, the processor 211 detects all four types of audios i.e. the braking audio, the collision impact audio, the horn audio and/or the passenger audio. Further, the processor 211 determines that the collision impact (i.e. amplitude and/or the frequency of the collision impact audio) is greater than a second threshold, then an output with an intense accident state is generated by the processor 211 of the system 101. Such second threshold may be set automatically by the system 101 or may also be manually configured by a user of the system 101. In other words, the audio signals for all four types (i.e. bakes, horn, collision impact and passenger sound) are detected along with the collision impact is very strong or loud. In other words, the passengers are screaming, the vehicle's horn is also buzzing, and vehicle's brakes are applied in a hard manner along with two vehicles have colliding hardly and with loud impact. This leads to an output generation of the intense accident state implying an intense accident has happened.

In the rule-based algorithm for outputting the no accident state, the processor 211 does not detect any captured audio signals or there is an absence of the captured audio signals. In such situation, no accident is outputted by the processor 211.

In the rule-based algorithm for outputting the pre-accident state, the processor 211 detects only three types of audios i.e. the braking audio, the horn audio and/or the passenger audio. Herein, the collision impact audio is not present and is not detected by the microphone 207 and/or the sensors 217. In other words, in case, the passengers are shouting as they can see that their vehicle is about to be collided with other nearby vehicle, horn is buzzing loudly to avoid such collision, and vehicle's brakes are also applied in a hard manner, but the collision of the vehicles is yet to happen (i.e. before or pre-accident). This leads to an output generation of the pre-accident state implying an accident is about to happen.

Exemplary Table 1 below depicts all four outputs (i.e. a no accident state, a pre-accident state, a light accident state, and an intense accident state) generated by the rule-based algorithm for each type of audio signals/events (braking events, accident collision impact, a horn, or a passenger audio events/signal).

TABLE 1
Exemplary

| | No | Pre- | Light | Intense |
|---|---|---|---|---|
| | Accident | Accident | Accident | Accident |
| | State | State | State | State |
| Braking Audio | No | Yes | Yes | Yes |
| Collision | No | No | Yes (Light | Yes (Strong |
| Impact Audio | | | Collision) | Collision) |
| Horn Audio | No | Yes | Yes | Yes |
| Passenger | No | Yes | Yes | Yes |
| Scream Audio | | | | |

The processor 211 of the system 101 may generate the confidence score for each of the predicted accident state as described above. For an example, initially due to only brake-based audio, the confidence value can be 20%. Then the audio signal from the horn is detected and the confidence value can be 40%. Additionally, few milli-seconds later, the passenger screams are detected, and the confidence value can be increased to 70%. Finally, if audio signals that indicates a crash or collision (e.g. a BANG sound) are detected then the confidence score can be over 90%. These values and audio signal weights are configurable by the system 101 or by the user of the system 101.

The present disclosure also encompasses the system 101 to validate the output 305 using non-audio data if the confidence value is below a third threshold. The third threshold may be set automatically by the system 101 or may also be manually configured by a user of the system 101. Every time the system 101 generates a confidence value, the generated confidence value is compared by the processor 211 with the third threshold. If the confidence value is above a third threshold (for an example, 60%), an output is generated. If the confidence value is below a third threshold (for an example, 60%), an output is not generated by the system 101.

In some exemplary embodiments, the non-audio data comprising at least one of: an imagery of an environment of the vehicle, a probe data from other vehicles, an accident update from the mapping platform 103 etc. The imagery of the environment of the vehicle may be received from nearby cameras installed on roads where the accident has occurred or about to occur. The probe data from other vehicles may be acquired from the mapping platform 103 or other nearby vehicle on the road where the accident has occurred or about to occur.

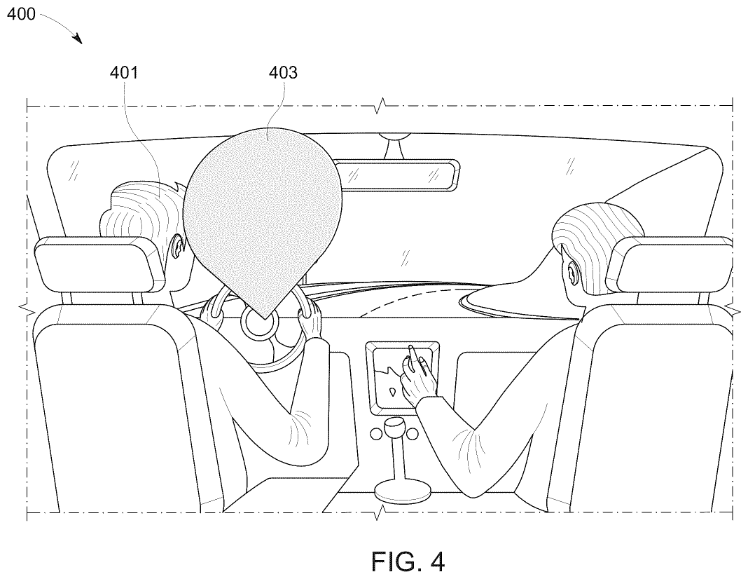

FIG. 4 illustrates an exemplary scenario 400 of triggering an airbag 403 of a vehicle in a pre-accident state, in accordance with an example embodiment. As explained in FIG. 3 above, if the pre-accident state is generated as an output by the processor 211 of the system 101, the airbag 403 of the vehicle is automatically triggered by the processor 211 of the system 101. Such automatic triggering of the airbag 403 is performed based on the output 305 generated by the processor 211 and would provide safety to the passenger/s 401 seating in the vehicle.

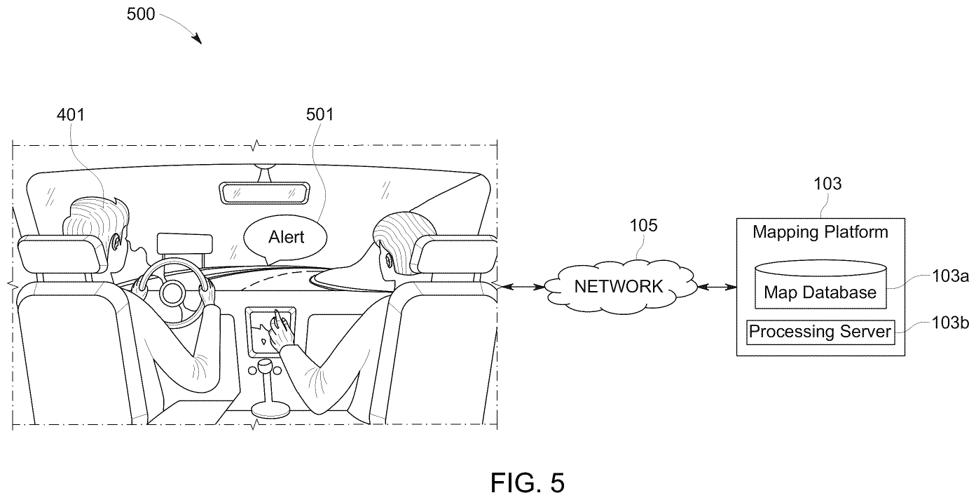

FIG. 5 illustrates an exemplary scenario 500 of sending an alert based on a pre-accident state, in accordance with an example embodiment. As explained in FIG. 3 above, if the pre-accident state is generated as the output 305 by the processor 211 of the system 101, the processor 211 of the system 101 may generate an alert 501 and may communicate the generated alert to the transmitter 203 of the system 101. The communication interface 201 of the system 101 may display the alert to the passenger 211 inside the vehicle before the vehicle is collided with other vehicle. The transmitter 203 of the system 101 then may transmit the alert 501 to the mapping platform 103 so as to enable the mapping platform 103 to update the map database 103a. The transmitter 203 of the system 101 may also transmit the alert 501 to nearby vehicles about the predicted accident of the vehicle to avoid an accident zone. The transmitter 203 of the system 101 may also transmit the alert 501 to nearby hospitals to send an ambulance to the accident zone.

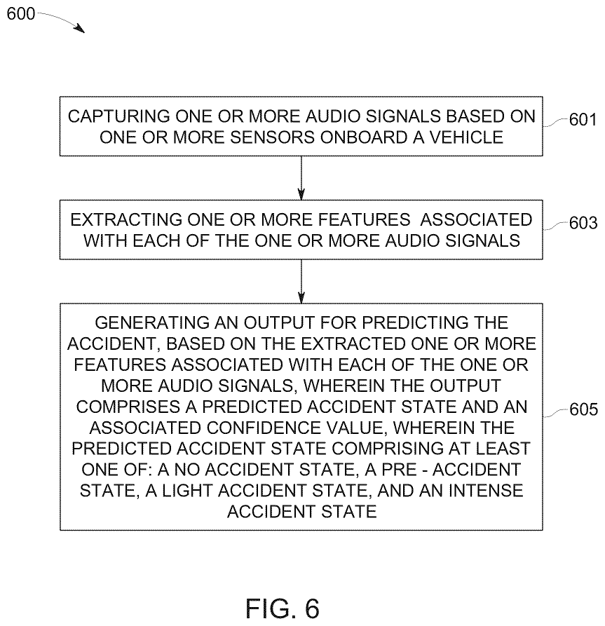

FIG. 6 illustrates a flow diagram of a method 600 for predicting an accident, in accordance with an example embodiment. It will be understood that each block of the flow diagram of the method 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 213 of the system 101, employing an embodiment of the present invention and executed by a processor 211. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 600 illustrated by the flowchart diagram of FIG. 6 is used for providing navigational instructions. Fewer, more, or different steps may be provided.

At step 601, the method 600 comprises capturing one or more audio signals based on one or more sensors 217 onboard a vehicle. Such one or more sensors 217 as well as the microphone 207 are part of a system 101 which may be integrated in the vehicle as explained above. Further, the captured one or more audio signals comprise audio associated with at least one of: braking events, accident collision impact, a horn, or a passenger.

At step 603, the method 600 comprises extracting one or more features associated with each of the one or more audio signals. The processor 211 of the system 101 extracts features such as amplitude and frequency of each of the audio signal. The extracted features (such as amplitude and frequency) of each of the audio signal are fed into the machine learning interface 215 of the system 101

At step 605, the method 600 comprises generating an output for predicting the accident, based on the extracted one or more features associated with each of the one or more audio signals. Further, the output comprises a predicted accident state and an associated confidence value. Also, the predicted accident state comprising at least one of: a no accident state, a pre-accident state, a light accident state, and an intense accident state. For this, the processor 211 determines that the collision impact is less than a first threshold or greater than a second threshold to generate the output. This has been explained above in greater details in Table 1 and FIG. 3.

The method 600 may be implemented using corresponding circuitry. For example, the method 600 may be implemented by an apparatus or system comprising a processor, a memory, and a communication interface of the kind discussed in conjunction with FIG. 2A.

In some example embodiments, a computer programmable product may be provided. The computer programmable product may comprise at least one non-transitory computer-readable storage medium having stored thereon computer-executable program code instructions that when executed by a computer, cause the computer to execute the method 600.

In an example embodiment, an apparatus for performing the method 600 of FIG. 6 above may comprise a processor (e.g. the processor 211) configured to perform some or each of the operations of the method of FIG. 6 described previously. The processor may, for example, be configured to perform the operations (601-605) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (601-605) may comprise, for example, the processor 211 which may be implemented in the system 101 and/or a device or circuit for executing instructions or executing an algorithm for processing information as described above.

In this way, example embodiments of the invention results in providing an early warning or an alert for an accident which is about to be occurred (i.e. pre-accident state). The invention may also provide trigger airbag of the vehicle in case of a pre-accident is determined. The invention also provide navigation to users based on prediction of an accident. The invention also send alerts to nearby hospitals for aiding passenger of the vehicle who is about to encounter an accident.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A method for predicting an accident, the method comprising:
capturing one or more audio signals based on one or more sensors onboard a vehicle;
extracting one or more features associated with each of the one or more audio signals; and
generating an output for predicting the accident, based on the extracted one or more features associated with each of the one or more audio signals, wherein the output comprises a predicted accident state and an associated confidence value, wherein the predicted accident state comprising at least one of: a no accident state, a pre-accident state, a light accident state, and an intense accident state.

2. The method of claim 1, wherein the captured one or more audio signals comprise audio associated with at least one of: braking events, accident collision impact, a horn, or a passenger.

3. The method of claim 2, wherein the pre-accident state comprises detection of the audio of the braking events, audio of the horn and audio from the passengers.

4. The method of claim 3, wherein the pre-accident state further comprising triggering a vehicle's air bag.

5. The method of claim 3, further comprising sending an alert based on the pre-accident state detection.

6. The method of claim 2, wherein the light accident state comprises detection of the audio of the braking events, audio of the horn, audio from the passengers and accident collision impact wherein the collision impact is less than a first threshold.

7. The method of claim 2, wherein the intense accident state comprises detection of the audio of the braking events, audio of the horn, audio from the passengers and accident collision impact wherein the collision impact is greater than a second threshold.

8. The method of claim 2, wherein the no accident state comprises absence of the captured audio signals.

9. The method of claim 1, wherein the output is further validated using non-audio data if the confidence value is below a third threshold.

10. The method of claim 9, wherein the non-audio data comprising at least one of: an imagery of an environment of the vehicle, a probe data from other vehicles.

11. The method of claim 1, wherein the output is generated using machine learning algorithm.

12. A system for predicting an accident, the system comprising:
at least one non-transitory memory configured to store computer executable instructions; and
at least one processor configured to execute the computer executable instructions to:
capturing one or more audio signals based on one or more sensors onboard a vehicle.
extracting one or more features associated with each of the one or more audio signals; and
generating an output for predicting the accident, based on the extracted one or more features associated with each of the one or more audio signals, wherein the output comprises a predicted accident state and an associated confidence value, wherein the predicted accident state comprising at least one of: a no accident state, a pre-accident state, a light accident state, and an intense accident state.

13. The system of claim 12, wherein the captured one or more audio signals comprise audio associated with at least one of: braking events, accident collision impact, a horn, or a passenger.

14. The system of claim 13, wherein the pre-accident state comprises detection of the audio of the braking events, audio of the horn and audio from the passengers.

15. The system of claim 14, wherein the pre-accident state further comprising triggering a vehicle's air bag.

16. The system of claim 14, further comprising sending an alert based on the pre-accident state detection.

17. The system of claim 13, wherein the light accident state comprises detection of the audio of the braking events, audio of the horn, audio from the passengers and accident collision impact wherein the collision impact is less than a first threshold.

18. The system of claim 13, wherein the intense accident state comprises detection of the audio of the braking events, audio of the horn, audio from the passengers and accident collision impact wherein the collision impact is greater than a second threshold.

19. The system of claim 13, wherein the no accident state comprises absence of the captured audio signals.

20. The system of claim 12, wherein the output is further validated using non-audio data if the confidence value is below a third threshold.

21. The system of claim 20, wherein the non-audio data comprising at least one of: an imagery of an environment of the vehicle, a probe data from other vehicles.

22. The system of claim 12, wherein the output is generated using machine learning algorithm.

23. A computer programmable product comprising a non-transitory computer readable medium having stored thereon computer executable instruction which when executed by one or more processors, cause the one or more processors to carry out operations for predicting an accident, the operations comprising:
capturing one or more audio signals based on one or more sensors onboard a vehicle.
extracting one or more features associated with each of the one or more audio signals; and
generating an output for predicting the accident, based on the extracted one or more features associated with each of the one or more audio signals, wherein the output comprises a predicted accident state and an associated confidence value, wherein the predicted accident state comprising at least one of: a no accident state, a pre-accident state, a light accident state, and an intense accident state.
